(19) United States
(12) Patent Application Publication
(10) Pub. No.: US 2004/0198451 A1
(43) Pub. Date: Oct. 7, 2004

(54) Tower top antenna structure with fiber optic communications link

(75) Inventor: Johnsy C. Varghese, The Colony, TX (US)

Correspondence Address: WOOD, HERRON & EVANS, LLP, 2700 CAREW TOWER, 441 VINE STREET, CINCINNATI, OH, 45202, US

(73) Assignee: Andrew Corporation, Orland Park, IL

(21) Appl. No.: 10/166,892

(22) Filed: Jun. 11, 2002

(51) Int. Cl. H04B 1/38; H04M 1/00

(52) U.S. Cl. 455/562.1; 455/561

(57) ABSTRACT

An intermediate frequency (IF) fiber optic communications link communicates receive and transmit signals between a distributed active antenna and base station electronics in an antenna installation. In addition, a tower top antenna structure incorporates both an RF transceiver and an optical transceiver in connection with a distributed active antenna to permit conversion between the RF signals utilized by a distributed active antenna with optical IF signals communicated over the fiber optic communications link. Complementary electronics at the base station then convert between the optical IF signals and digital IF signals for interface with base station electronics.

### FIELD OF THE INVENTION

The invention generally relates to wireless communication, and in particular, relates to cellular communications towers and methods of interfacing a tower top antenna with base station electronics.

### BACKGROUND OF THE INVENTION

Wireless data communication has become increasingly pervasive in contemporary society. Cell phones have become ubiquitous for voice communications, and increasingly wireless data applications such as electronic messaging and Internet access, continue to be added to existing systems.

To support wireless data communication, subscriber units communicate wirelessly with fixed antennas typically mounted on towers or other tall structures. Geographic areas are partitioned into “cells” with various towers positioned along the boundaries of such cells to handle subscribers over such geographical regions. Fixed antennas, and more importantly the towers upon which those antennas are mounted, are typically expensive to build and maintain, and are often restricted by zoning regulations and opposed by local groups based upon aesthetic reasons. Furthermore, as technology advances, newer and more advanced communications networks are continually being developed, with each communication network requiring its own infrastructure of antennas and electronics to communicate with subscribers throughout a geographical region. Furthermore, even as new networks are developed, older networks continue to be used, which adds to the proliferation of antennas, towers, and the like.

Due to the aforementioned cost and difficulties associated with adding new towers, collocation, whereby multiple carriers or networks share the same tower, is increasingly relied upon to expand capacity and functionality within a geographic region. However, a number of issues can limit the number of antennas that are mounted on a given tower or other antenna installation.

Conventional antenna installations, for example, have typically relied on tower top antennas with base station electronics disposed at the base of the tower for performing such activities as amplifying uplink and downlink signals sent to or received from subscriber units, interfacing these signals with a wired or wireless network backbone, and performing other control and monitoring operations associated with the installation. Particularly where amplification of signals is performed at the base of a tower, it has been found that significant power losses in the cables utilized to transmit and receive signals from the base station electronics to the tower top antennas often require substantial power amplification, which adds cost, increases energy consumption, and often decreases the reliability of a tower installation due to added heat generation. Furthermore, greater amplification also typically introduces linearity problems, requiring expensive linearity correction circuitry in the amplifiers to address these concerns. Moreover, when collocation of multiple antennas on a given tower structure is used, base station amplification for these multiple antennas can further compound the aforementioned issues.

Furthermore, the coaxial cables typically utilized to interface a base station amplifier with an antenna are relatively heavy and increase tower and wind load. As additional antennas are added, the loading becomes more pronounced, and as such, the inherent weight of the electronics and cabling run to a tower top can become a limiting factor on the antenna capacity for a particular tower.

One manner of alleviating the current concerns associated with base station amplification is to utilized tower top amplification, whereby amplifiers are mounted in closer proximity to the antennas at the top of a tower or other structure. By doing so, lower cable losses are experienced when communicating signals between the tower top and base station, and as a result, lower amplification, and thus less expensive amplifiers, may be used. Furthermore, linearity concerns are not as important due to the relatively lower amplification required. Another advantage of placing amplification at the tower top is the reclamation of space at the base for expansion of base station electronics.

While locating amplifiers at the tower top address a number of the aforementioned concerns, a number of additional concerns are still present. Tower and wind loading, for example, may be even more pronounced in connection with tower top amplification due to the need for additional electronic circuitry and cabling that is disposed at the tower top. Furthermore, installation and repair is often more problematic due to the difficulty with working at the tower top as opposed to at the base station. As a result, there are still often a number of restrictions on collocation of antennas even when tower top amplification is used.

Therefore, a significant need exists in the art for a manner of facilitating the communication of signals between the tower top and base station electronics of an antenna installation, particularly to reduce tower and wind load, and thus enhance the antenna collocation capacity of an antenna installation.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a block diagram of an antenna installation incorporating a fiber optic communications link consistent with the invention.

FIG. 2 is a block diagram of an alternate distributed active antenna for use in the antenna installations of FIG. 1, and incorporating distributed low noise amplifiers associated with receive antenna elements.

FIG. 3 is an alternate antenna installation to that of FIG. 1, where analog signals are communicated across a fiber optic communications link.

FIG. 4 is a block diagram of an alternative antenna structure incorporating multiplexing of I and Q components of an IF signal on a common fiber in a fiber optic communications link consistent with the invention.

FIG. 5 is a block diagram of another alternate antenna structure incorporating multiplexing of IF transmit and receive signals in a fiber optics communications link consistent with the invention.

FIG. 6 is a block diagram of yet another alternate antenna structure incorporating multiplexing of multiple transmit and receive signals for communication between a base station and multiple tower units over a fiber optic communications link consistent with the invention.

### DETAILED DESCRIPTION OF THE DRAWINGS

The embodiments described hereinafter address the problems associated with the prior art by utilizing an intermediate frequency (IF) fiber optic communications link to communicate receive and transmit signals between a distributed active antenna and base station electronics in an antenna installation. In particular, a tower top antenna structure incorporates both an RF transceiver and an optical transceiver in connection with a distributed active antenna to permit conversion between the RF signals utilized by a distributed active antenna with optical IF signals communicated over the fiber optic communications link. Complementary electronics at the base station then convert between the optical IF signals and digital IF signals for interface with base station electronics.

By incorporating an IF fiber optic communications link in a manner consistent with the invention, tower and wind loading commonly associated with coaxial cabling is substantially reduced by the replacement of such cabling with relatively lighter weight fiber optic cabling. Moreover, in many embodiments, a single multi-fiber cable can replace multiple coaxial cables. Furthermore, in some embodiments, a power supply cable may also be incorporated with one or more fibers into a composite cable to power the tower top electronics. In addition, area is often freed up at the base station, and installation is often simplified compared to conventional structures. Moreover, due to the reduced losses associated with fiber optic communications, the amplification requirements required in the tower top structure may be reduced, thus improving efficiency, reliability and heat generation, and lowering amplification costs.

Moreover, as will become more apparent below, an RF transceiver and optic transceiver may often be integrated into the same housing or enclosure as a distributed active antenna, which further improves reliability, installation and maintenance due to the incorporation of all such components into a single enclosure. Moreover, in many embodiments, a housing may be constructed to incorporate integrated heat sinks for the purpose of dissipating any heat generated by tower top electronics.

In addition, by communicating IF signals over a fiber optic communications link, and performing RF up/down conversion at the tower top, no RF transceiver is typically required at the base station.

Moreover, in many instances, the communication of an IF signal over a fiber optic communications link substantially simplifies the interface with the base station electronics, and particularly with the channelizers typically utilized in a base station to handle multiple channels of communication with a given antenna. In particular, many conventional channelizers, e.g., for use in CDMA installations, are readily adapted to natively output and receive as input, digital IF signals via pairs of in-phase (I) and quadrature (Q) connectors. It will be appreciated that for other protocols, e.g., GSM, EDGE, TDMA, etc., other types of IF signals may be communicated over a fiber optic communications link consistent with the invention.

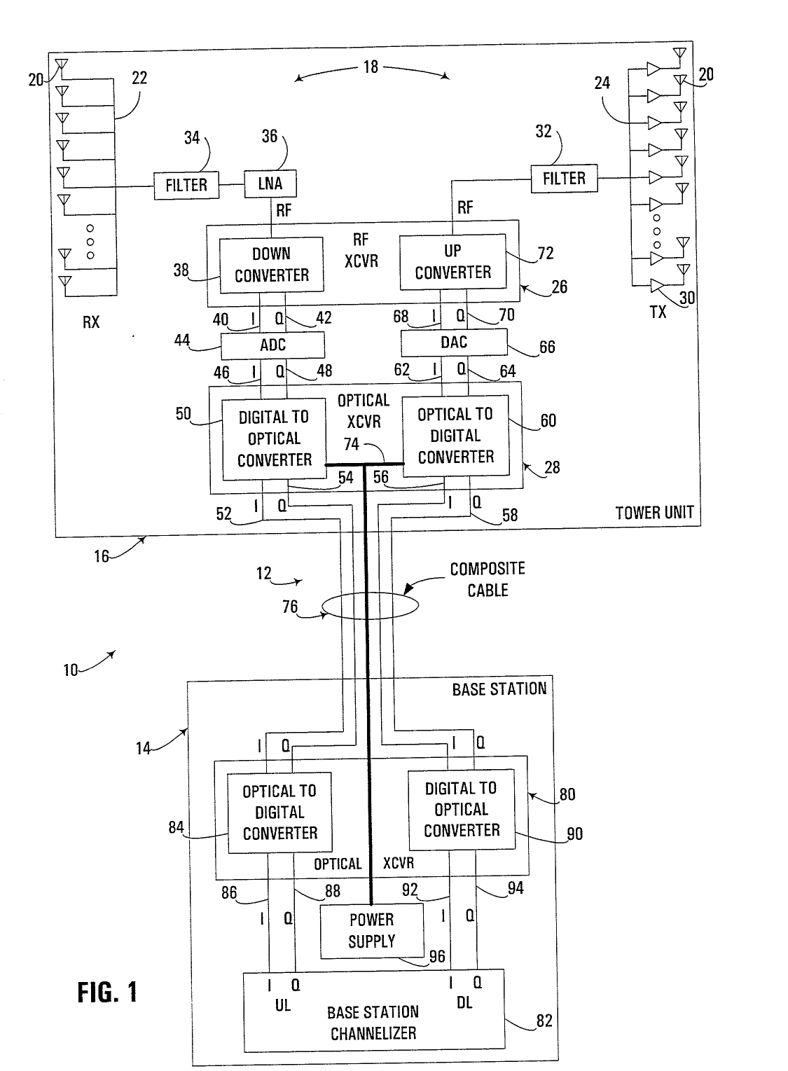

Now turning to the Drawings, wherein like numbers denote like parts throughout the several views, FIG. 1 illustrates an exemplary antenna installation 10 incorporating a fiber optic communications link 12 consistent with the invention. Fiber optic communications link 12 is utilized to interface a base station 14 with a tower top antenna structure 16, although it will be appreciated that a tower top antenna structure may also be utilized on structures other than a tower, e.g., on buildings and other tall structures.

Tower top antenna structure 16 incorporates a distributed active antenna 18 incorporating a plurality of antenna elements 20 arranged into receive and transmit arrays 22, 24. Consistent with the invention, distributed active antenna 18 is interfaced with an RF transceiver 26 and an optical transceiver 28 to communicate transmit (or downlink) and receive (or uplink) signals between antenna 18 and base station 14.

Distributed active antenna 18 may take any number of forms including, for example, the various designs described in U.S. patent application Ser. No. 09/299,850, filed Apr. 26, 1999; Ser. No. 09/422,418, filed Oct. 21, 1999; and Ser. No. 09/846,790, filed May 1, 2001; all of which were filed by Judd et al., and all of which are incorporated by reference herein.

In general, a distributed active antenna consistent with the invention includes a plurality of antenna elements 20, with a plurality of distributed amplifiers 30 coupled to each element 20 utilized in connection with transmitting RF signals to subscriber units. In addition, a filter 32 is also typically coupled between RF transceiver 26 and the transmit array 24 of antenna 18. Moreover, with respect to the receive array 22, typically a filter 34 and low noise amplifier (LNA) 36 are coupled intermediate receive array 22 and RF transceiver 26.

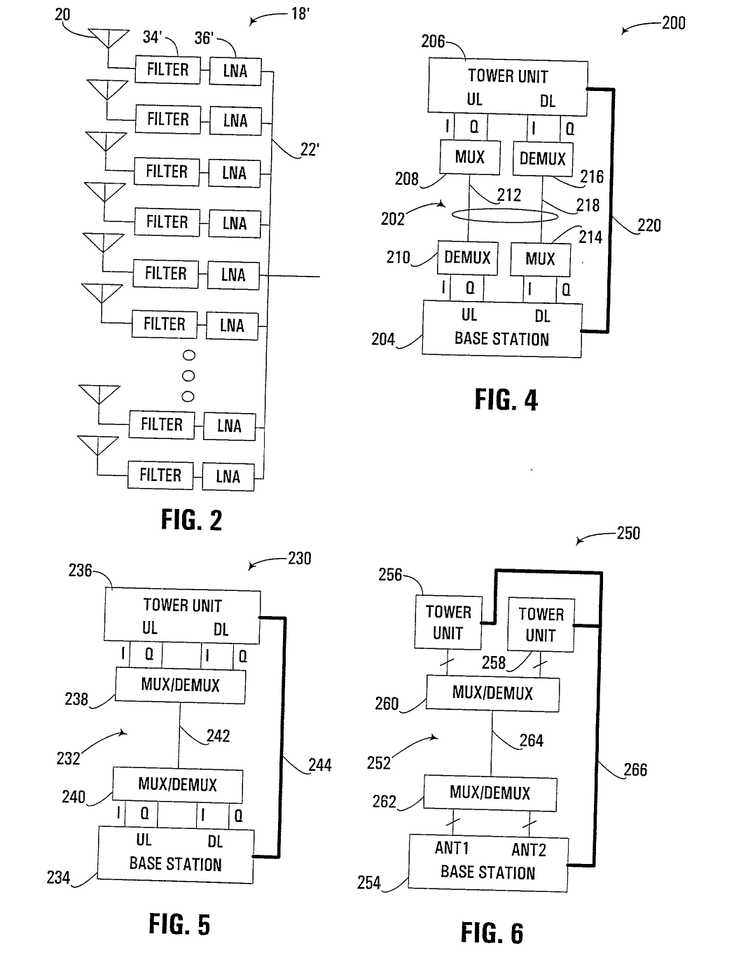

Various alternative designs may be utilized for a distributed active antenna consistent with the invention. For example, as shown in FIG. 2, an alternate distributed active antenna 18′ may incorporate an alternate receive array 22′ whereby a plurality of distributed filters 34′ and LNAs 36′ are individually coupled to antenna elements 20 in the array. Other alternative designs will be appreciated by one of ordinary skill in the art having the benefit of the instant disclosure.

Returning to FIG. 1, for the receive, or uplink path, RF transceiver 26 incorporates a downconverter 38 which downconverts the RF signal output by LNA 36 of antenna 18 to an IF signal, typically represented via separate in-phase (I) and quadrature (Q) components, output on lines 40, 42. The I and Q IF receive signals are then digitized via an analog-to-digital converter (ADC) 44, which outputs digital signals on lines 46, 48. A digital-to-optical converter 50 disposed in optical transceiver 28 then converts these digital signals to optical signals output on a pair of fibers 52, 54 in fiber optic communications link 12. In this embodiment, therefore, a receiver circuit is defined in the tower top antenna structure that includes at least downconverter 38, ADC 44 and digital-to-optical converter 50.

For the transmit or downlink path, tower top antenna structure 16 receives an IF optical signal from base station 14 separated into I and Q components on fibers 56, 58 in fiber optic communications link 12. An optical digital converter 60 in optical transceiver 28 then converts these components to digital signals on lines 62, 64, with these digital signals converted to analog by digital-to-analog converter (DAC) 66. DAC 66 outputs analog IF signals on lines 68, 70, which are used by an upconverter 72 in RF transceiver 26 to generate an RF transmit signal for transmission by distributed active antenna 18. In this embodiment, therefore, a transmitter circuit is defined in the tower top antenna structure that includes at least upconverter 72, DAC 66 and optical-to-digital converter 60.

To power the various electronic components in tower top antenna structure 16, a power cable 74 may also be routed between base station 14 and antenna structure 16. In some instances, it may be desirable to provide this power cabling separate from fiber optic communications link 12, or in the alternative, a composite cable 76, incorporating both the electrically conductive power cabling 74 and fibers 52, 54, 56 and 58, may be used in the alternative.

RF transceiver 26 and optical transceiver 28 may each take a number of configurations consistent with the invention. For example, both downconverter 38 and upconverter 72 of RF transceiver 26 may be disposed on separate integrated circuits (IC's) or the same IC. Likewise, the digital-to-optical and optical-to digital converters 50, 60 in optical transceiver 28 may be implemented using separate IC's or the same IC. Moreover, ADC 44 and DAC 66 may optionally be integrated onto the same IC's as utilized for either of transceivers 26, 28. Moreover, in some implementations, both transceivers 26, 28 may be integrated in the same IC.

Moreover, it is typically desirable to incorporate transceivers 26, 28 into the same housing or enclosure as distributed active antenna 18. In addition, a heat sink may be incorporated into the housing for heat dissipation. In such embodiments, typically the only external connections required would be for a power supply and for the fibers in link 12. However, in other embodiments, such components may be disposed in separate housings without departing from the invention.

From the perspective of the base station 14, providing a fiber optic interface with tower top antenna structure 16 often requires little more than the incorporation of an optical transceiver 80 between the antenna structure and the base station channelizer 82. In particular, an optical-to-digital converter 84 in optical transceiver 80 converts the optical I and Q receive signals on fibers 52 and 54 to digital representations on lines 86 and 88. Lines 86 and 88 terminate at the I and Q inputs on the uplink connector for channelizer 82. Similarly, on the downlink channel, channelizer 82 outputs digital I and Q transmit signals on lines 92 and 94, which feed into a digital-to-optical converter 90 for output over fibers 56, 58.

One advantage of the aforementioned configuration is based upon the relative ease of coupling optical transceiver 80 to channelizer 82. In particular, channelizer 82 typically includes I and Q connectors for the uplink and downlink paths that are output to a backplane in the base station equipment rack. As such, the addition of an optical transceiver in the uplink and downlink paths often may be implemented through the use of a custom card that interfaces to and communicates with the channelizer 82 through the backplane. As such, the addition of an optical transceiver does not require any modification of channelizer 82.

Base station 14 is also illustrated as including a power supply 96 coupled to power cabling 74, for powering the various components in antenna structure 16.

It will be appreciated that the use of an integrated antenna structure such as described for antenna structure 16 provides a number of advantages over conventional designs. Wind and tower loading are typically reduced due to the use of fiber optic cabling and the reduction in separate tower top amplifiers and transceiver boxes. In addition, installation is substantially simplified, with a reduced likelihood of installation errors, due to the use of a decreased number of connections. Moreover, the integration of transceivers with the distributed amplifiers often eliminates the need for additional high power amplifiers between the transceiver and antenna, which can improve efficiency, reliability, cost and cooling requirements of the system. As discussed above, however, it is not necessary to integrate the receivers and the distributed active antenna within the same enclosure or housing in all designs consistent with the invention.

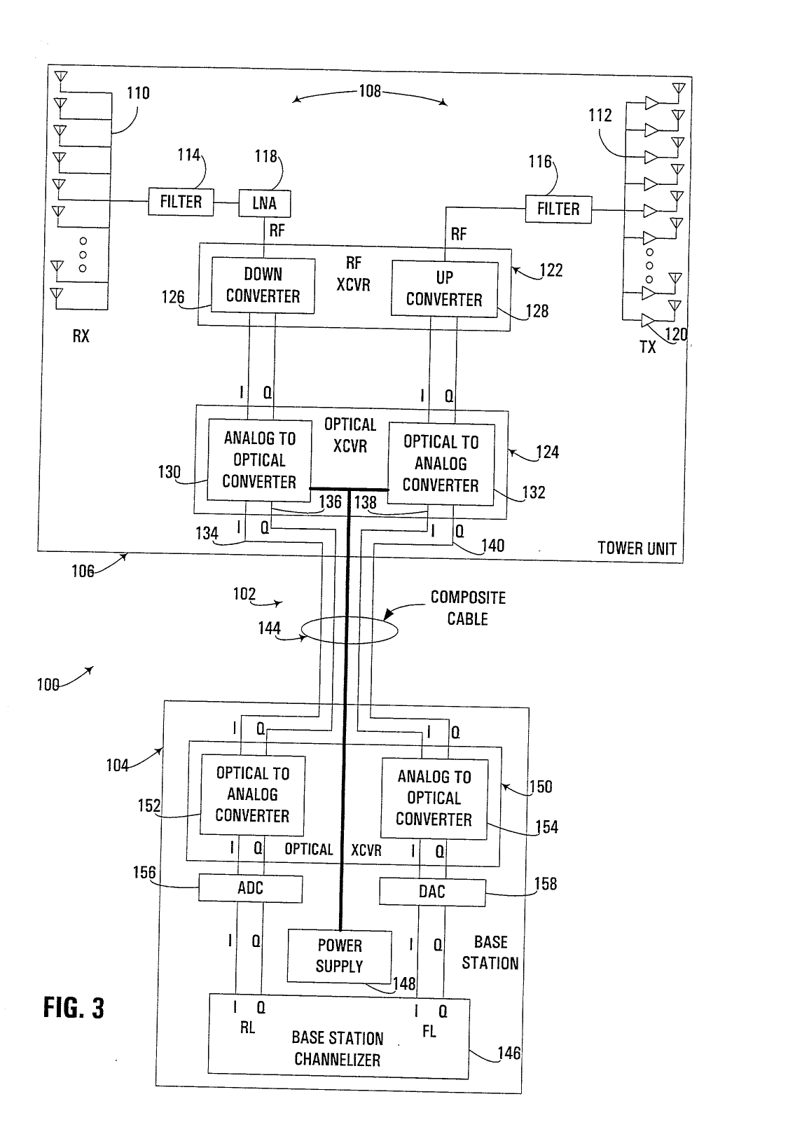

Various modifications may be made to the embodiment illustrated in FIG. 1 consistent with the invention. For example, as shown in FIG. 3, an alternate antenna installation 100 may include a fiber optic communications link 102 for interfacing a base station 104 with an antenna structure 106. The antenna structure may include a distributed active antenna 108 similar to antenna 18 described above, and including receive and transmit arrays 110, 112, as well as filters 114, 116, LNA 118 and distributed amplifiers 120. Likewise, RF transceiver 122 is similarly configured to RF transceiver 26, incorporating a downconverter 126 and upconverter 128. However, rather than incorporating an ADC and DAC intermediate transceivers 122, 124, no analog/digital conversion is performed at tower top, and optical transceiver 124 incorporates an analog-to-optical converter 130 and an optical-to-analog converter 132 on the respective uplink and downlink paths. As such, optical representations of analog I and Q IF signals are transmitted and received over fibers 134, 136, 138 and 140. In addition, power cabling 142 may also be incorporated into a separate cable, or within a composite cable 144.

With respect to base station 104, similar to base station 14, a base station channelizer 146 and power supply 148 are incorporated along with an optical transceiver 150. However, to accommodate the analog signals communicated in optical form over fibers 134, 136, 138 and 140, optical transceiver 150 includes an optical-to-analog converter 152 and analog-to-optical converter 154, along with a complementary ADC 156 and DAC 158 intermediate transceiver 150 and channelizer 146. By performing analog/digital conversion at the base station, rather than the tower top antenna structure, replacement or upgrade of the analog/digital conversion electronics would be substantially simplified.

Another modification that may be made to the aforementioned embodiments is the use of multiplexing to reduce the number of fibers required to communicate signals between the tower top antenna structure and a base station. In particular, it will be appreciated that the extremely high bandwidth supported by fiber optic communications is often sufficient to support the communication of a large number of intermediate frequency signals over the same fiber. However, given the low cost and light weight of optical fibers, it will be appreciated that in many instances, multiplexing of multiple signals may not be economically justified.

For example, as shown in FIG. 4, an alternate antenna installation 200 may include a fiber optic communications link 202 between a base station 204 and a tower unit 206. On the uplink path, a multiplexer 208 disposed in the tower unit, and a demultiplexer 210 disposed in the base station, may be utilized to multiplex the I and Q components of an IF receive signal on a common fiber 212. Likewise, on the downlink path, a multiplexer 214 disposed in the base station and a demultiplexer 216 disposed in the tower unit may be utilized to multiplex the I and Q components of an IF transmit signal over a common fiber 218. Additional power cabling illustrated at 220 may also be included.

Furthermore, as shown in FIG. 5, it may also be desirable to multiplex both the up and downlink paths over a common fiber. In particular, an antenna installation 230 includes a fiber optic communications link 232 interfacing a base station 234 with a tower unit 236. A pair of multiplex/demultiplex components 238, 240 are provided on the tower unit and base station to multiplex the I and Q components of both the receive and transmit IF signals for communication over a common fiber 242, with power supplied over power cabling 244 as above.

Moreover, in some instances, it may be desirable to drive multiple antennas with a common base station, and to multiplex the IF signals associated with these multiple antennas over a common fiber. FIG. 6, for example, illustrates an antenna illustration 250 including a fiber optic communications link 252 interfacing a base station 254 with multiple tower units 256, 258. Multiplexer/demultiplexer components 260, 262 are disposed at each of the tower top and base station, and utilized to multiplex the transmit and receive IF signals for the multiple tower units over a common fiber 264. The provision of power to tower units 256 and 258 may be made by a power cabling 266, which may be routed individually or collectively to the tower units.

It will be appreciated that various degrees of multiplexing and demultiplexing may be utilized consistent with the invention, including the selective multiplexing of I and Q components, uplink and downlink paths, and paths for multiple antennas, consistent with the invention.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A tower top antenna structure for use in communicating with a base station in a cellular communications network, the tower top antenna structure comprising:
(a) a distributed active antenna;
(b) a receiver circuit coupled to the distributed active antenna and including a downconverter and an optical transmitter, the receiver circuit configured to receive a radio frequency (RF) receive signal from the distributed active antenna and generate therefrom a downconverted optical receive signal for transmission to the base station over a fiber optic communications link; and
(c) a transmitter circuit coupled to the distributed active antenna and including an optical receiver and an upconverter, the transmitter circuit configured to receive an optical transmit signal from the base station over the fiber optic communications link and generate therefrom an upconverted RF transmit signal for transmission by the distributed active antenna.

2. The antenna structure of claim 1, wherein the distributed active antenna comprises a plurality of antenna elements and a plurality of amplifiers coupled thereto.

3. The antenna structure of claim 2, wherein the plurality of antenna elements comprises a plurality of transmit antenna elements, the antenna structure further comprising a plurality of receive antenna elements and at least one low noise amplifier coupled to the plurality of receive antenna elements.

4. The antenna structure of claim 1, wherein the downconverter is configured to downconvert the RF receive signal to an intermediate frequency (IF) receive signal, and wherein the receiver circuit further comprises an optical converter configured to receive the IF receive signal and drive the optical transmitter to generate the optical receive signal in response thereto.

5. The antenna structure of claim 4, wherein the downconverter is configured to output the IF receive signal in an analog format, wherein the optical converter is configured to receive the IF receive signal in a digital format, and wherein the receiver circuit further comprises an analog to digital converter coupled intermediate the downconverter and the optical converter.

6. The antenna structure of claim 4, wherein the downconverter is configured to output the IF receive signal as separate In-phase (I) and Quadrature (Q) receive signals, and wherein the optical converter is configured to transmit the optical receive signal by transmitting I and Q optical receive signals over the fiber optic communications link.

7. The antenna structure of claim 6, wherein the fiber optic communications link includes I and Q receive fibers, and wherein the optical converter is configured to communicate the I and Q optical receive signals over the I and Q receive fibers, respectively.

8. The antenna structure of claim 6, wherein the receiver circuit is configured to multiplex the I and Q optical receive signals for transmission over a common fiber in the fiber optic communications link.

9. The antenna structure of claim 1, wherein the transmitter circuit further comprises an optical converter coupled to the optical receiver and configured to output an IF transmit signal, and wherein the upconverter is configured to upconvert the IF transmit signal to the RF transmit signal.

10. The antenna structure of claim 9, wherein the upconverter is configured to receive the IF transmit signal in an analog format, wherein the optical converter is configured to transmit the IF transmit signal in a digital format, and wherein the transmitter circuit further comprises a digital to analog converter coupled intermediate the optical converter and the upconverter.

11. The antenna structure of claim 9, wherein the optical converter is configured to output the IF transmit signal as separate In-phase (I) and Quadrature (Q) transmit signals, and wherein the upconverter is configured to generate the RF transmit signal therefrom.

12. The antenna structure of claim 11, wherein the fiber optic communications link includes I and Q transmit fibers, and wherein the optical converter is configured to receive separate I and Q optical transmit signals over the I and Q receive fibers, respectively.

13. The antenna structure of claim 11, wherein the transmitter circuit is configured to receive the I and Q optical transmit signals from a common fiber in the fiber optic communications link, and to demultiplex the I and Q optical transmit signals therefrom.

14. The antenna structure of claim 1, further comprising a multiplexer configured to multiplex a second optical receive with the first optical receive signal for transmission over a common fiber in the fiber optical communications link.

15. The antenna structure of claim 1, further comprising a multiplexer and a demultiplexer configured to communicate the optical receive signal and the optical transmit signal over a common fiber in the fiber optical communications link.

16. The antenna structure of claim 1, further comprising a housing within which the distributed active antenna, the receiver circuit and the transmitter circuit are all disposed.

17. A tower top structure for use in connection with a distributed active antenna to communicate with a base station in a cellular communications network, the tower top structure comprising:
(a) a receiver circuit configured to be coupled to a distributed active antenna and including a downconverter and an optical transmitter, the receiver circuit configured to receive a radio frequency (RF) receive signal from the distributed active antenna and generate therefrom a downconverted optical receive signal for transmission to the base station over a fiber optic communications link; and
(b) a transmitter circuit configured to be coupled to the distributed active antenna and including an optical receiver and an upconverter, the transmitter circuit configured to receive an optical transmit signal from the base station over the fiber optic communications link and generate therefrom an upconverted RF transmit signal for transmission by the distributed active antenna.

18. An apparatus for use in a cellular communications network, the apparatus comprising:
(a) a base station;
(b) a fiber optic communications link coupled to the base station;
(c) a distributed active antenna; and
(d) a tower top structure coupled to the distributed active antenna and the fiber optic communications link, the tower top structure comprising:
(i) a tower top receiver circuit including a downconverter and an optical transmitter, the tower top receiver circuit configured to receive a radio frequency (RF) receive signal from the distributed active antenna and output therefrom a downconverted optical receive signal over the fiber optic communications link; and
(ii) a tower top transmitter circuit including an optical receiver and an upconverter, the tower top transmitter circuit configured to receive an optical transmit signal from the fiber optic communications link and generate therefrom an upconverted RF transmit signal for transmission by the distributed active antenna.

19. The apparatus of claim 18, wherein the base station further comprises:
(a) a channelizer having receive and transmit inputs;
(b) a base station receiver circuit coupled to the fiber optic communications link and the receive input of the channelizer; and
(c) a base station transmit circuit coupled to the fiber optic communications link and the transmit input of the channelizer.

20. The apparatus of claim 19, wherein the downconverter is configured to convert the RF receive signal to an intermediate frequency (IF) receive signal including in-phase (I) and quadrature (Q) components, wherein the tower top receiver circuit is configured to output the optical receive signal over the fiber optic communications link as separate I and Q optical receive signals, and wherein the base station receiver circuit is configured to convert the I and Q optical receive signals to a second IF receive signal.

21. The apparatus of claim 20, wherein the tower top receiver circuit includes an analog to digital converter and a digital to optical converter, whereby the I and Q optical receive signals respectively include digital representations of the I and Q components of the IF receive signal.

22. The apparatus of claim 20, wherein the base station receiver circuit includes an analog to digital converter and the tower top receiver circuit includes an analog to optical converter, whereby the I and Q optical receive signals respectively include analog representations of the I and Q components of the IF receive signal.

23. The apparatus of claim 19, wherein the upconverter is configured to generate the RF transmit signal from an IF transmit signal including in-phase (I) and quadrature (Q) components, wherein the tower top transmitter circuit is configured to receive the optical transmit signal from the fiber optic communications link as separate I and Q optical transmit signals, and wherein the base station transmitter circuit is configured to generate the I and Q optical transmit signals from a second IF transmit signal.

24. The apparatus of claim 23, wherein the tower top transmitter circuit includes a digital to analog converter and an optical to digital converter, whereby the I and Q optical transmit signals respectively include digital representations of the I and Q components of the IF transmit signal.

25. The apparatus of claim 23, wherein the base station transmitter circuit includes a digital to analog converter and the tower top transmitter circuit includes an optical to analog converter, whereby the I and Q optical transmit signals respectively include analog representations of the I and Q components of the IF transmit signal.

26. A tower top antenna structure for use in communicating with a base station in a cellular communications network, the tower top antenna structure comprising:
(a) a distributed active antenna;
(b) a radio frequency (RF) transceiver coupled to the distributed active antenna and configured to convert transmit and receive signals between RF and intermediate frequency (IF) representations; and
(c) an optical transceiver coupled to the RF transceiver and to a fiber optic communications link, the optical transceiver configured to convert the transmit and receive signals between IF and optical representations.

27. The antenna structure of claim 26, wherein the IF representation of each of the transmit and receive signals comprises an in-phase (I) and quadrature (Q) component, and wherein the optical representation of each of the transmit and receive signals comprises an in-phase (I) and quadrature (Q) component.

28. The antenna structure of claim 27, wherein the optical representation of each of the transmit and receive signals comprises a digital I component and a digital Q component.

29. The antenna structure of claim 27, wherein the optical representation of each of the transmit and receive signals comprises an analog I component and an analog Q component.

30. A method of communicating with a base station in a cellular communications network, the method comprising:
(a) receiving a radio frequency (RF) receive signal from a distributed active antenna;
(b) generating a downconverted optical receive signal from the RF receive signal using a tower top receiver circuit that includes a downconverter and an optical transmitter;
(c) communicating the downconverted optical receive signal to the base station over a fiber optic communications link;
(d) receiving an optical transmit signal from the base station over the fiber optic communications link;
(e) generating an upconverted RF transmit signal from the optical transmit signal using a tower top transmitter circuit that includes an optical receiver and an upconverter; and
(f) transmitting the upconverted RF transmit signal using the distributed active antenna.

31. The method of claim 30, wherein generating the downconverted optical receive signal includes downconverting the RF receive signal to an intermediate frequency (IF) receive signal.

32. The method of claim 31, wherein generating the downconverted optical receive signal includes converting the IF receive signal from an analog format to a digital format prior to converting the IF receive signal to the optical receive signal.

33. The method of claim 31, wherein downconverting the RF receive signal includes generating separate In-phase (I) and Quadrature (Q) receive signals for the IF receive signal.

34. The method of claim 33, wherein generating the downconverted optical receive signal includes converting the I and Q receive signals to I and Q optical receive signals, and wherein communicating the downconverted optical receive signal includes transmitting the I and Q optical receive signals over separate fibers in the fiber optic communications link.

35. The method of claim 33, wherein generating the downconverted optical receive signal includes converting the I and Q receive signals to I and Q optical receive signals, and wherein communicating the downconverted optical receive signal includes multiplexing the I and Q optical receive signals over a common fiber in the fiber optic communications link.

36. The method of claim 30, wherein generating the upconverted RF transmit signal includes converting the optical transmit signal to an IF transmit signal, and upconverting the IF transmit signal to RF.

37. The method of claim 36, wherein generating the upconverted RF transmit signal includes converting the IF transmit signal from a digital format to an analog format prior to upconverting the IF transmit signal to RF.

38. The method of claim 36, wherein converting the optical transmit signal to an IF transmit signal includes receiving the optical transmit signal as separate In-phase (I) and Quadrature (Q) transmit signals.

39. The method of claim 38, wherein receiving the optical transmit signal includes receiving separate I and Q optical transmit signals over separate fibers in the fiber optic communications link.

40. The method of claim 38, wherein receiving the optical transmit signal includes receiving I and Q optical transmit signals over a common fiber in the fiber optic communications link, the method further comprising demultiplexing the I and Q optical transmit signals.
